(19) United States
(12) Patent Application Publication
(10) Pub. No.: US 2007/0221034 A1
(43) Pub. Date: Sep. 27, 2007

(54) Method and apparatus for converting a CD-jukebox to digital jukebox

(76) Inventors: Tom Pigoski, San Leandro, CA (US); Rick Caviglia, San Leandro, CA (US)

Correspondence Address: LARRY D. JOHNSON, P.O. BOX 470277, CELEBRATION, FL, 34747, US

(21) Appl. No.: 11/366,332

(22) Filed: Mar. 2, 2006

(51) Int. Cl. G10H 3/18

(52) U.S. Cl. 84/1

(57) ABSTRACT

A method and apparatus for converting a CD-jukebox to a digital jukebox provides a flat-panel touch-screen monitor or all-in-one panel computer to the door of a CD-jukebox to interface with the existing audio and payment components within the jukebox. The method may be used with floor-mount or wall-mount type CD-jukeboxes. Some or all of the existing CD-jukebox components to be left in place and reused if desired. The apparatus includes a bezel member that supports the touch-screen monitor, and which mounts to the jukebox door replacing the title window of a traditional CD-jukebox. A control computer connected to the touch-screen monitor runs software that enables the music selections and controls the playback of the music on the jukebox.

### CROSS REFERENCE TO RELATED APPLICATIONS

The present application claims the benefit of the filing date of U.S. Provisional Patent Application Ser. No. 60/______, filed 2 Mar. 2005, and U.S. Provisional Patent Application Ser. No. 60/______, filed 2 Mar. 2005.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to audio systems, CD players, and jukeboxes, and more particularly to an improved method and apparatus for the conversion of conventional CD-based floor-mount or wall-mount jukeboxes to touch-screen operated digital and/or CD-jukeboxes.

### BACKGROUND INFORMATION AND DISCUSSION OF RELATED ART

There have been over 250,000 CD-based jukeboxes installed in various locations since 1990, most of which are floor-mount type jukeboxes, with a lesser amount of wall-mount type jukeboxes. Over the past several years, sales of new CD-jukeboxes have dropped off and have been replaced by sales of a new type of jukebox based upon the selection and delivery of digital music files stored on hard drives within a computer housed in the jukebox, and selected for playback via a touchscreen monitor.

There have been several attempts to offer conversion kits which would retrofit the cabinet of a floor-mount type CD-jukebox with components that enable the CD-jukebox to operate as a digital jukebox. These conversion kits have required significant retrofit to the existing jukebox cabinet to support the heavy CRT-type touch-screen monitor anchored to the cabinet enclosure, and also require a substantial replacement of other components within the jukebox.

Digital wall-mount jukeboxes are typically re-engineered from the ground up to incorporate the components necessary to run the digital platform. There are currently no known methods in the prior art for converting a traditional wall-mount CD-jukebox to a digital jukebox.

U.S. Pat. No. 6,346,951 to Mastronardi discloses a process for selecting a recording on an audiovisual reproduction system which consists of displaying a number of windows on a touch screen as an interface with a user. Items of information are stored in a bulk memory and are representative of an image of the album cover that is associated with each window and whose corresponding musical recording is stored in the bulk memory of the reproduction system. Each zone of a window is associated, via the touch-screen interface software, with at least one address for accessing the items of information in the database that is stored in the bulk memory belonging to the album cover whose image is displayed in the window that is touched by the user.

U.S. Pat. No. 6,755,744 to Nathan, et al. describes a communication device between an audiovisual information playback system and at least one electronic game machine, each game machine including a viewing means for interacting with the user and a means of payment, wherein each electronic game machine is connected to the playback system via a network interface and an associated network. The device also includes specific managing means for managing means of payment, a viewing means and an interactive means to enable the selection and payment of at least one selection stored on the playback system, the managing means being triggered by activation of the electronic game machine.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### SUMMARY OF THE INVENTION

The present invention provides a method and apparatus for converting a CD-jukebox to a digital jukebox. The invention overcomes the disadvantages of the prior art by providing a system for mounting a flat-panel touch-screen or all-in-one panel computer to the existing door of a CD-jukebox to enable the conversion of the CD-jukebox to a digital jukebox, and to interface with the existing audio and payment components within the jukebox. The inventive method may be used with floor-mount type CD-jukeboxes, as well as wall-mount type CD-jukeboxes.

The invention provides a low cost method for upgrading a CD-based jukebox to a digital jukebox and greatly simplifies the requirements for installation of the kit components. The inventive method also allows for some or all of the existing CD-jukebox components to be left in place and reused if desired.

The inventive apparatus includes a frame or bezel member that supports a lightweight touch-screen monitor or flat panel computer, and which mounts to the jukebox door replacing the title window of a traditional CD-jukebox. The bezel itself may completely fill the space previously occupied by the title window glass, or may incorporate additional components to fill the space or for aesthetic reasons. The bezel is preferably at least nominally larger than the title window aperture in the horizontal dimension, vertical dimension, or both, so that it rests and is supported on one or more edges of the window aperture, and does not pass through the aperture when released. The touch-screen monitor that mounts within the bezel provides the interface for a patron to select music on the converted jukebox.

A control computer connected to the touch-screen monitor runs software that enables the music selections and controls the playback of the music on the jukebox. The control computer may be part of a panel computer (if so installed as the touch-screen monitor component) or may be a separate computer (if a stand-alone touch-screen monitor is installed). The control computer may provide audio directly to the existing jukebox audio components, or may communicate via additional audio processing controllers including the existing amplifier, pre-amplifier, and CD mechanism of the jukebox. The system may incorporate an input/output (I/O) controller (e.g., serial, parallel, USB, Bluetooth or other similar wire-based or wireless protocol) which facilitates communication between the software and the payment and audio devices within the jukebox, or may incorporate direct communication from these devices to the control computer.

One or more harness assemblies may interconnect the touch-screen monitor mounted within the frame of the door of the jukebox to the control computer, and the interface controller (if applicable), to existing or new components within the jukebox.

It is therefore an object of the present invention to provide a new and improved digital jukebox.

It is another object of the present invention to provide a new and improved method for converting a CD-jukebox to a digital jukebox.

A further object or feature of the present invention is a new and improved bezel apparatus for installing a touch-screen monitor into a CD-jukebox to convert it to a digital jukebox.

An even further object of the present invention is to provide a novel CD-jukebox to digital jukebox conversion kit.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram of the components of a CD-jukebox to digital jukebox conversion kit of this invention;

FIG. 2 is a front perspective view of a title window replacement bezel used in the conversion of a conventional CD-jukebox;

FIG. 3 is a rear perspective view of the title window replacement bezel of FIG. 2;

FIG. 4 is a front perspective view of a title window replacement bezel and touch-screen monitor being lowered into the title window aperture of a floor-mount CD-jukebox;

FIG. 5 is a rear elevation view of a raised door of a floor-mount CD-jukebox illustrating the title window replacement bezel and touch-screen monitor in place in the window aperture;

FIGS. 6A and 6B are cutaway side elevation views of a conventional floor-mount CD-jukebox;

FIGS. 7A and 7B are cutaway side elevation views of a prior art conversion of a conventional floor-mount CD-jukebox to a digital jukebox;

FIGS. 8A and 8B are cutaway side elevation views of the inventive conversion of a conventional floor-mount CD-jukebox to a digital jukebox;

FIGS. 9A and 9B are front and side elevation views, respectively, of a conventional wall-mount CD-jukebox; and

FIGS. 10A and 10B are front and side elevation views, respectively, of the inventive conversion of a conventional wall-mount CD-jukebox to a digital jukebox.

### DETAILED DESCRIPTION OF THE INVENTION

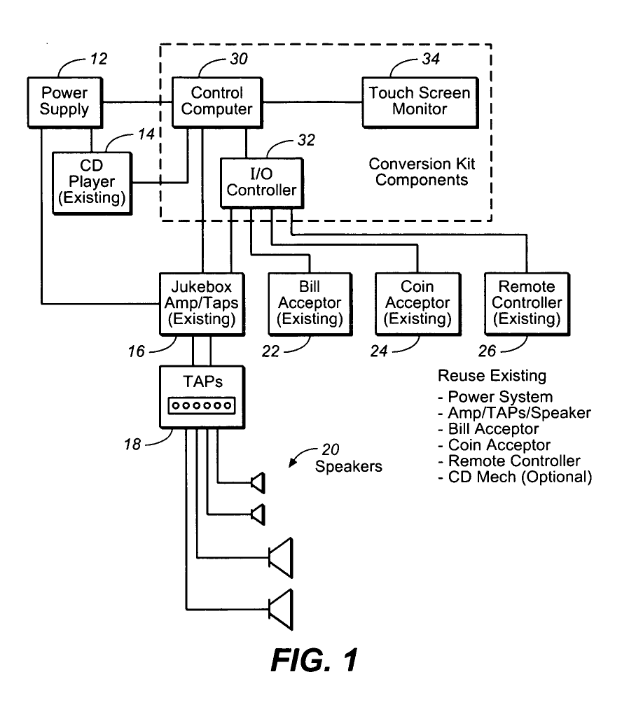

Referring to FIGS. 1 through 10B, wherein like reference numerals refer to like components in the various views, there is illustrated therein a new and improved method and apparatus for converting a CD-jukebox to a digital jukebox.

FIG. 1 is a block diagram of the components of a CD-jukebox to digital jukebox conversion kit of this invention. Original components include power supply 12, CD player 14, amplifier 16, taps 18, speakers 20, bill acceptor 22, cash acceptor 24, and remote controller 26. Conversion kit components include control computer 30, I/O controller 32, and touch-screen monitor 34. This method may reuse all of the existing components.

FIG. 2 is a front perspective view of a title window replacement bezel 40 used in the conversion of a conventional CD-jukebox. Bezel 40 may include lower channel 42 for engagement with the lower edge of the jukebox cabinet window glass aperture, as described infra. Monitor support bracket 44 secures the touch-screen monitor (not illustrated in this view) to the bezel.

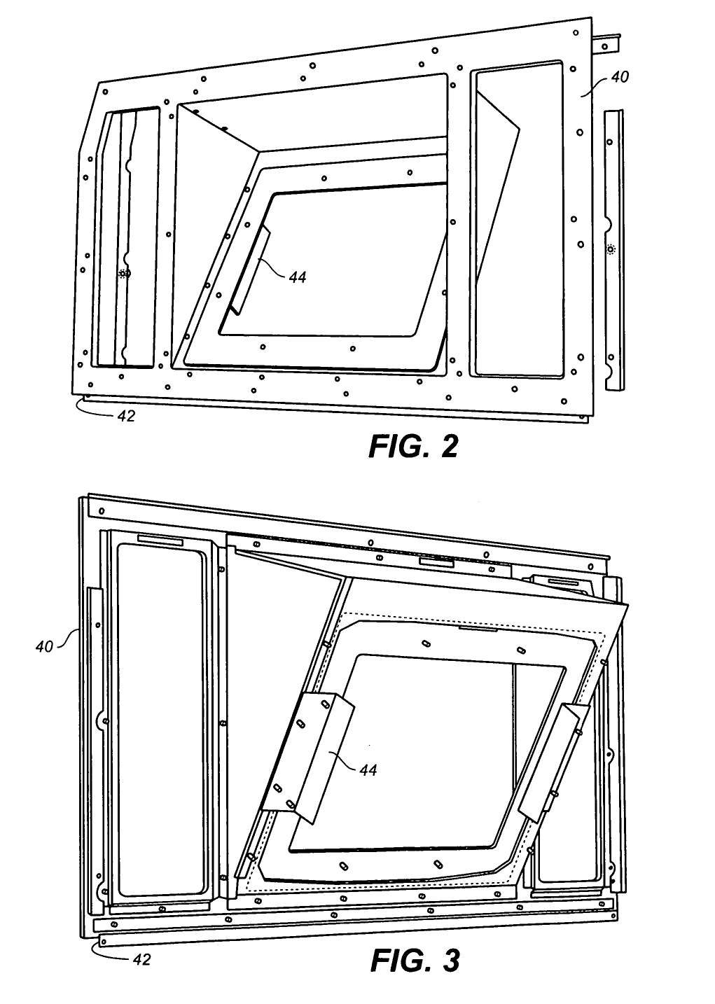

FIG. 3 is a rear perspective view of the title window replacement bezel 40 of FIG. 2, again illustrating the optional lower channel 42 and monitor support bracket 44.

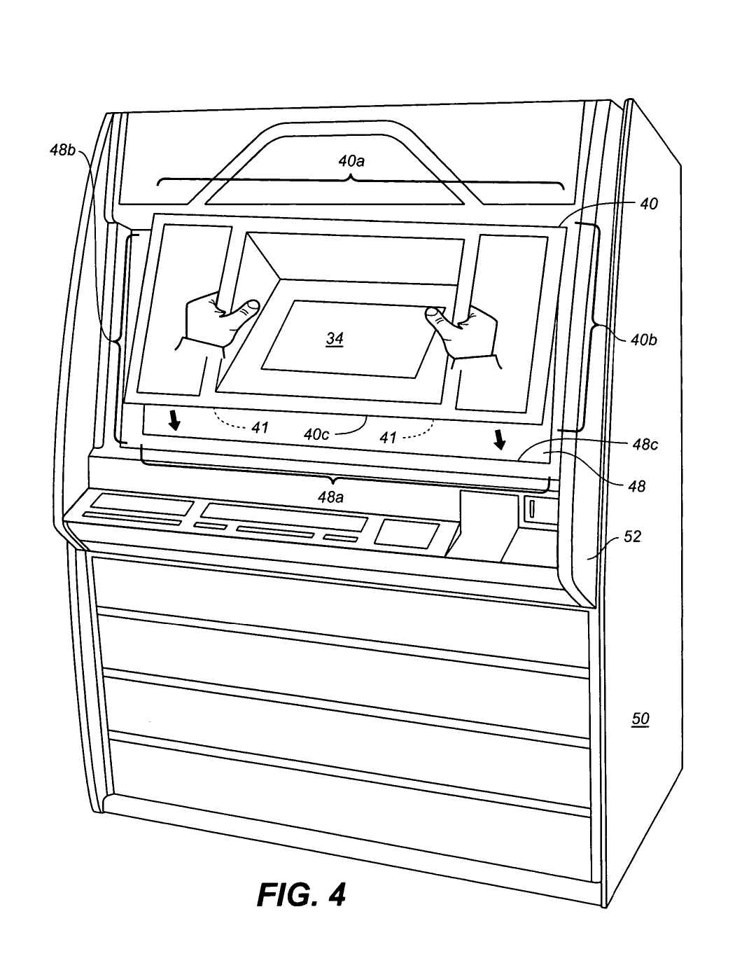

FIG. 4 is a front perspective view of a title window replacement bezel 40 and touch-screen monitor 34 being lowered into the title window aperture 48 of a floor-mount CD-jukebox 50 having a door 52. Window aperture 48 has a horizontal dimension 48a and a vertical dimension 48b, and includes a lower edge 48c. Bezel 40 has a horizontal dimension 40a preferably at least nominally greater than the window aperture horizontal dimension 48a, and a vertical dimension 40b preferably at least nominally greater than the window aperture vertical dimension 48b. This ensures that the bezel 40 rests and is supported on one or more edges of the window aperture, and does not pass through the aperture when released. In addition, bezel 40 may include one or more studs or nubs 41, or other structural feature, extending rearwardly from bezel lower edge 40c to contact and rest upon window aperture lower edge 48c, thereby positioning and supporting the bezel on the aperture. This arrangement is a variation of the bezel embodiment depicted in FIGS. 2 and 3, which utilize a channel 42 for this support.

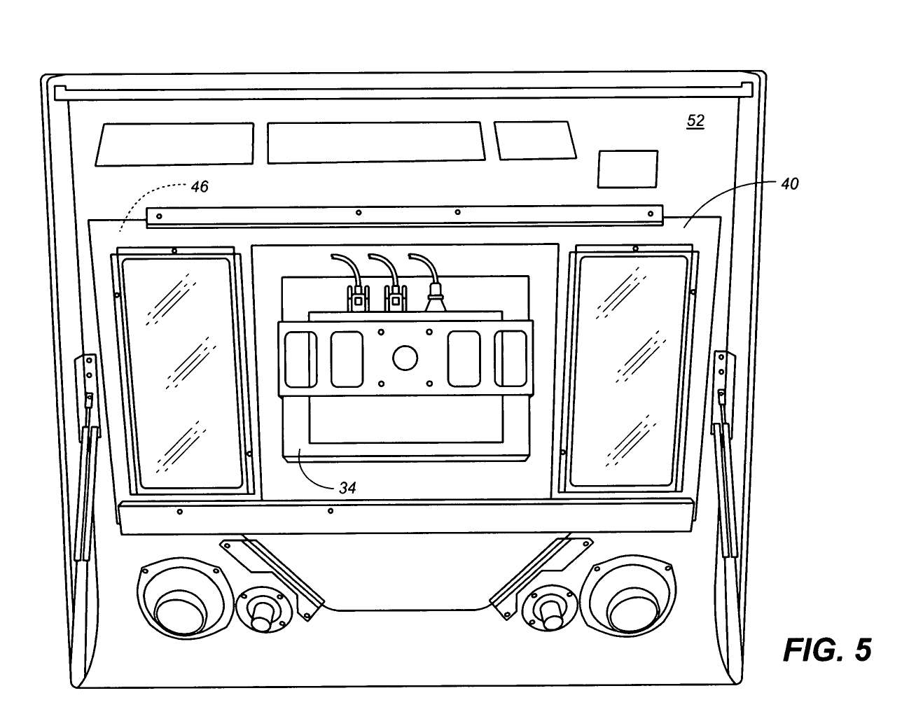

FIG. 5 is a rear elevation view of a raised door 52 of a floor-mount CD-jukebox illustrating the title window replacement bezel 40 and touch-screen monitor 34 in place in the window aperture 48.

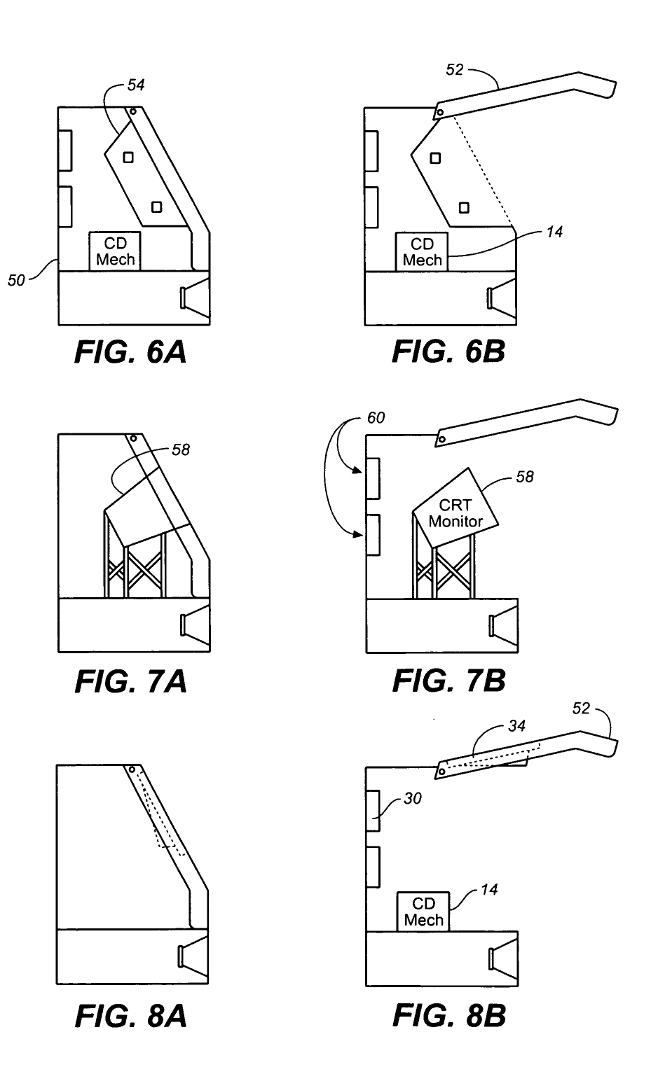

FIGS. 6A and 6B are cutaway side elevation views of a conventional floor-mount CD-jukebox 50 with door 52, title rack 54, window 56, and CD mechanism 14. Title rack 54 is removed during conversion to a digital jukebox.

FIGS. 7A and 7B are cutaway side elevation views of a prior art conversion of a conventional floor-mount CD-jukebox to a digital jukebox. CRT-type touch-screen monitor 58 must be anchored to the jukebox cabinet, which requires removal of most of the original components as well as significant rework and installation of replacement controllers 60.

FIGS. 8A and 8B are cutaway side elevation views of the inventive conversion of a conventional floor-mount CD-jukebox to a digital jukebox. Mounting of flat-panel touch-screen monitor 34 in the door 52 greatly simplifies the upgrade and allows the existing components to remain in place.

The title window replacement bezel 40 provides a distinct solution to prior art methods of CD-jukebox conversion. The problem with using the existing mounting (that holds the title page window glass) is that the mounting points (studs) molded into the plastic door structure are often not reinforced, and they snap off when the weight of a touch-screen monitor is applied. The inventive bezel 40 drops in from the front of the window aperture, and the bottom of the bezel preferably includes a channel, nubs, or other structural feature that contacts or hooks on to the lower edge 48c of the title window frame aperture 48 of the existing jukebox door (see FIG. 4). The bezel assembly can then be allowed to fall forward into the aperture, covering up the entire title window opening, because the bezel is nominally larger than the window aperture. The door can then be opened and the bezel assembly secured in place by securing it to the existing window frame with a set of brackets, pinch brackets, clamps, or other hardware securing it to the window frame.

The inventive kit may also include a bracket to hold the lower display glass in place. The mounting points (studs) that are molded into the door of some jukebox models tend to break off. The inventive bracket bypasses the original mounting points, which are not reinforced, and extends out to a set of OEM reinforced mounting points.

The inventive kit may also include LED display and button panel brackets to hold the glass and graphics that replace the original LED display and button panel, which are no longer used when the jukebox is converted from a CD player to digital.

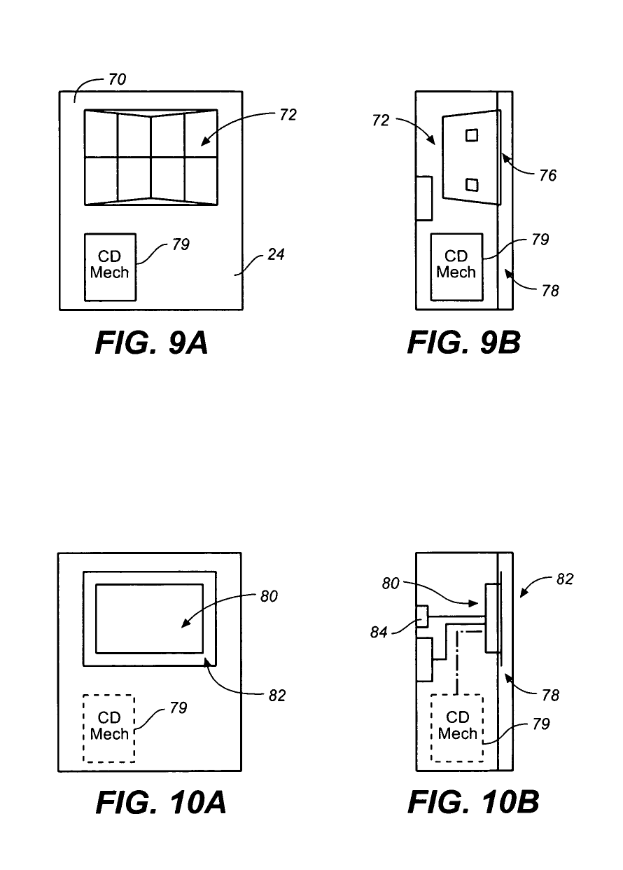

FIGS. 9A and 9B are front and side elevation views, respectively, of a conventional wall-mount CD-jukebox 70, including title rack 72 (supported by the cabinet 74), title window 76, door 78, and CD mechanism 79.

FIGS. 10A and 10B are front and side elevation views, respectively, of the inventive conversion of a conventional wall-mount CD-jukebox to a digital jukebox. Flat panel touch-screen 80 is supported by support frame 82, which replaces the original title window, and is mounted to the door 78. New control computer 84 is installed in the existing space. All other existing components may be retained if desired.

In a preferred embodiment of the wall-mount conversion embodiment of the invention, the system includes a metal and acrylic frame assembly mounted to the door of the jukebox replacing the title window glass, a touch-screen monitor mounted within the frame assembly to the door of the jukebox, and a separate control computer, also mounted to the frame assembly, that provides audio output directly to the existing jukebox audio output components (e.g. amplifier) and which interfaces with existing payment, audio control components, and other control devices within the jukebox via a serial I/O controller.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A method for converting a CD-jukebox to a digital jukebox, the CD-jukebox having a title window in a window aperture, the aperture having a horizontal dimension and a vertical dimension, said method comprising the steps of:
removing the title window from the window aperture;
providing a bezel having a horizontal dimension and a vertical dimension, wherein at least one of the bezel dimensions is greater than the corresponding window aperture dimension, the bezel including a flat-panel touch-screen monitor; and
installing the bezel into the window aperture so that the bezel rests on the window aperture to support the bezel and the touch-screen monitor in the jukebox.

2. The method for converting a CD-jukebox to a digital jukebox of claim 1 wherein the window aperture has a lower edge, and further comprising the step of:
providing the bezel with a structural feature to engage the lower edge of the window aperture to support the bezel and the touch-screen monitor in the jukebox.

3. The method for converting a CD-jukebox to a digital jukebox of claim 1 wherein the structural feature to engage the lower edge of the window aperture comprises at least one nub.

4. The method for converting a CD-jukebox to a digital jukebox of claim 1 wherein the structural feature to engage the lower edge of the window aperture comprises a channel.

5. The method for converting a CD-jukebox to a digital jukebox of claim 1 wherein the flat-panel touch-screen monitor comprises a panel computer.

6. The method for converting a CD-jukebox to a digital jukebox of claim 1 further including the step of connecting a control computer to the touch-screen monitor to run software that enables the music selections and controls the playback of the music on the jukebox.

7. The method for converting a CD-jukebox to a digital jukebox of claim 6 wherein the control computer comprises a panel computer.

8. The method for converting a CD-jukebox to a digital jukebox of claim 1 further including the step of connecting an I/O controller to facilitate communication between the software and the payment and audio devices within the jukebox.

9. The method for converting a CD-jukebox to a digital jukebox of claim 1 wherein the bezel horizontal dimension and a vertical dimension are both greater than the corresponding window aperture dimensions.

10. The method for converting a CD-jukebox to a digital jukebox of claim 1 wherein the CD-jukebox is a floor-mount jukebox.

11. An apparatus for converting a CD-jukebox to a digital jukebox, the CD-jukebox having a window aperture having a horizontal dimension and a vertical dimension, said apparatus comprising:
a bezel member having a horizontal dimension and a vertical dimension, wherein at least one of said bezel dimensions is greater than the corresponding window aperture dimension; and
a flat-panel touch-screen monitor attached to said bezel, wherein said bezel can be installed into the window aperture so that said bezel rests on the window aperture to support said bezel and said touch-screen monitor in the jukebox.

12. The apparatus for converting a CD-jukebox to a digital jukebox of claim 11 wherein the window aperture has a lower edge, and said bezel includes a structural feature to engage the lower edge of the window aperture to support the bezel and the touch-screen monitor in the jukebox.

13. The apparatus for converting a CD-jukebox to a digital jukebox of claim 12 wherein said structural feature to engage the lower edge of the window aperture comprises at least one nub.

14. The apparatus for converting a CD-jukebox to a digital jukebox of claim 12 wherein said structural feature to engage the lower edge of the window aperture comprises a channel.

15. The apparatus for converting a CD-jukebox to a digital jukebox of claim 11 wherein said flat-panel touch-screen monitor comprises a panel computer.

16. The apparatus for converting a CD-jukebox to a digital jukebox of claim 11 further including a control computer connected to said touch-screen monitor to run software that enables the music selections and controls the playback of the music on the jukebox.

17. The apparatus for converting a CD-jukebox to a digital jukebox of claim 16 wherein said control computer comprises a panel computer.

18. The apparatus for converting a CD-jukebox to a digital jukebox of claim 11 further including an I/O controller connected to said touch-screen monitor to facilitate communication between the software and the payment and audio devices within the jukebox.
